(19) United States
(12) Patent Application Publication
(10) Pub. No.: US 2025/0116798 A1
(43) Pub. Date: Apr. 10, 2025

(54) DISPLAY DEVICE

(71) Applicant: AUO Corporation, Hsinchu City (TW)

(72) Inventors: Hao Shiun Yang, Hsinchu City (TW); Jian-Fu Chen, Hsinchu City (TW); Chien-Chi Chen, Hsinchu City (TW); Shang-Chiang Lin, Hsinchu City (TW); Wang-Shuo Kao, Hsinchu City (TW)

(73) Assignee: AUO Corporation, Hsinchu City (TW)

(21) Appl. No.: 18/814,615

(22) Filed: Aug. 26, 2024

(30) Foreign Application Priority Data
Oct. 6, 2023 (TW) 112138406

(51) Int. Cl. G02B 1/11; G02B 5/00

(52) U.S. Cl. CPC G02B 1/11; G02B 5/003

(57) ABSTRACT

A display device includes a display panel, a first adhesive layer, a diffusion layer, and an anti-glare film. The first adhesive layer is disposed on the display panel. The first adhesive layer is disposed between the display panel and the diffusion layer. The anti-glare film is disposed on the diffusion layer, wherein a thickness of the diffusion layer is greater than or equal to 15 microns.

### CROSS-REFERENCE TO RELATED APPLICATION

This application claims the priority benefit of Taiwan application serial no. 112138406, filed on Oct. 6, 2023. The entirety of the above-mentioned patent application is hereby incorporated by reference herein and made a part of specification.

### BACKGROUND OF THE INVENTION

### Field of the Invention

The invention relates to an electronic device, and in particular to a display device.

### Description of Related Art

As display device techniques continue to improve, the market has increasingly higher requirements for display screens. In display devices, the quantity of various optical films (such as anti-reflective films, diffusion films, brightness-enhancing films, etc.) is also gradually increasing for use in display devices for solving various technical issues such as uniform light output, anti-reflective light, etc.

However, as more and more optical films are disposed in display devices, phenomena such as unexpected reflection, diffusion, refraction, and interference between a plurality of films become increasingly complex and significant. In particular, the light diffusion structure of the surface of the anti-glare film may also cause uneven distribution of display light intensity on the display screen. As a result, the sparkling of the display screen becomes more severe, gradually affecting the quality of the display screen or causing user discomfort. How to make a plurality of optical films perform the respective functions thereof while reducing the sparkling of the display screen is actually an issue that relevant manufacturers still need to solve.

### SUMMARY OF THE INVENTION

The invention provides a display device that may effectively reduce the sparkling of a display screen on the basis of good anti-glare, and may provide a better display effect.

In an embodiment of the invention, a display device includes a display panel, a first adhesive layer, a diffusion layer, and an anti-glare film. The first adhesive layer is disposed on the display panel. The first adhesive layer is disposed between the display panel and the diffusion layer. The anti-glare film is disposed on the diffusion layer, wherein a thickness of the diffusion layer is greater than or equal to 15 microns.

Based on the above, in the display device of the invention, the diffusion layer is disposed between the first adhesive layer and the anti-glare film, and the thickness of the diffusion layer is controlled to be greater than or equal to 15 microns, thus effectively reducing the optical interference generated between the anti-glare film and other films, and further reducing the sparkling of the display screen, and the anti-glare film may also maintain the anti-reflective function thereof. The display device according to an embodiment of the invention may provide a good display screen and provide a good viewing experience in an environment in which the natural light is too strong or too dark, and in the front or side viewing angle of the display device.

In order to make the aforementioned features and advantages of the disclosure more comprehensible, embodiments accompanied with figures are described in detail below.

### BRIEF DESCRIPTION OF THE DRAWINGS

FIG. 1A is a cross-sectional schematic diagram of a display device according to the first embodiment of the invention.

FIG. 1B is a comparative schematic diagram of various modified embodiments of the display device of the first embodiment.

FIG. 1C and FIG. 1D are comparative schematic diagrams of various modified embodiments of the display device of the first embodiment.

FIG. 2 is a cross-sectional schematic diagram of a display device according to the second embodiment of the invention.

FIG. 3 is a cross-sectional schematic diagram of a display device according to the third embodiment of the invention.

### DESCRIPTION OF THE EMBODIMENTS

As used herein, “about,” “approximately,” “essentially,” or “substantially” includes the stated value and the average within an acceptable deviation range for the particular value as determined by one of ordinary skill in the art, taking into account the measurements in question and the specific amount of error associated with the measurements (i.e., limitations of the measurement system). For example, “about” may mean within one or a plurality of standard deviations of the stated value, or for example within ±30%, ±20%, ±15%, ±10%, ±5%. Furthermore, “about”, “approximately”, “essentially”, or “substantially” used herein may adopt a more acceptable deviation range or standard deviation according to the nature of measurement, cutting, or other properties, instead of one standard deviation applying to all properties.

In the drawings, the thickness of layers, films, panels, regions, etc., are exaggerated for clarity. It should be understood that when a device such as a layer, film, region, or base material is referred to as being “on” or “connected to” another device, it may be directly on or connected to the other device, or an intermediate device may also be present. On the other hand, when a device is “directly on another device” or “directly connected to” another device, an intermediate device is not present. As used in the present specification, “connected to” may refer to a physical and/or electrical connection.

Reference will now be made in detail to the exemplary embodiments of the invention, examples of which are illustrated in the accompanying drawings. Wherever possible, the same reference numerals are used in the figures and the descriptions to refer to the same or similar portions.

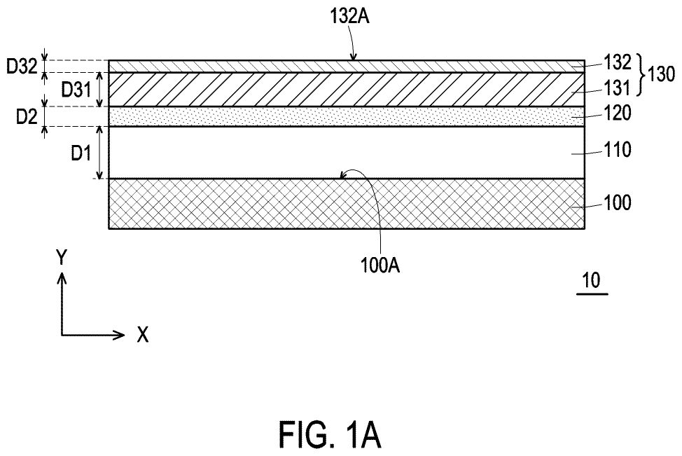

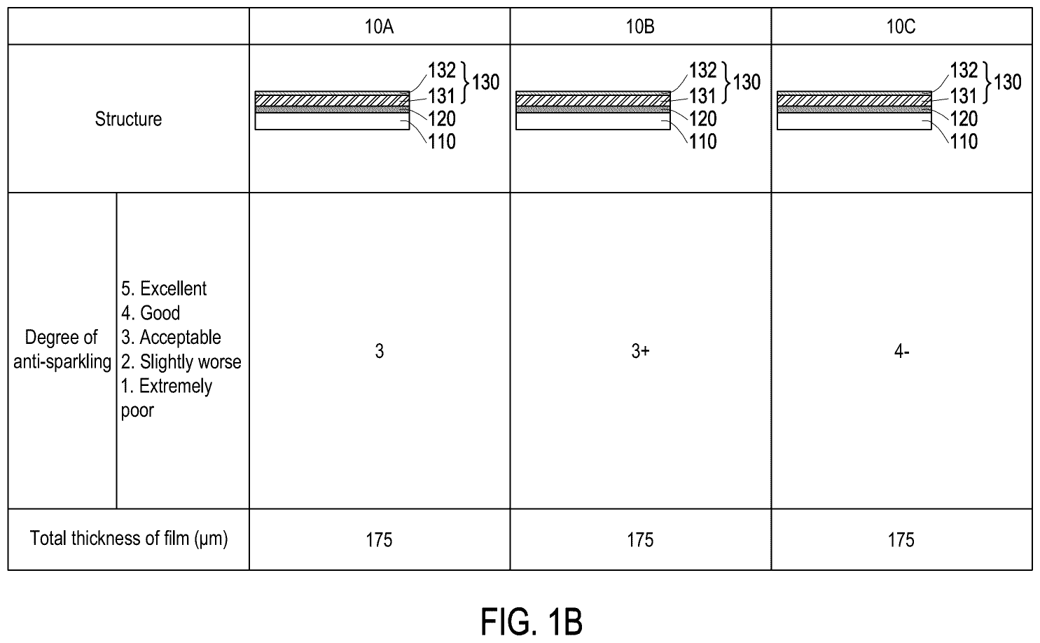

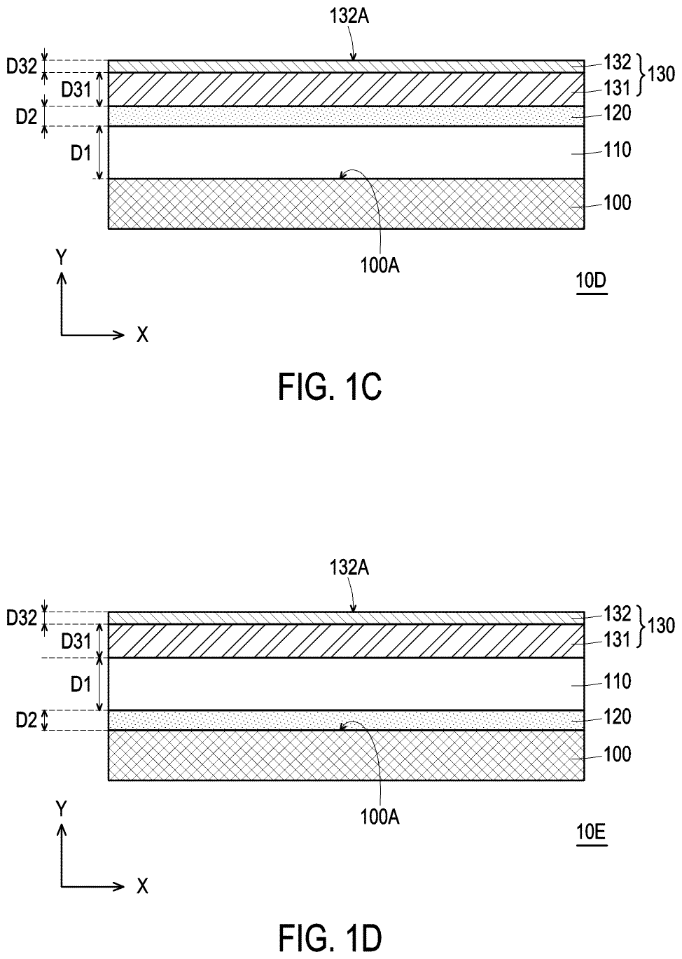

FIG. 1A is a cross-sectional schematic diagram of a display device according to the first embodiment of the invention. Referring to FIG. 1A, a display device 10 includes a display panel 100, a first adhesive layer 110, a diffusion layer 120, and an anti-glare film 130. The first adhesive layer 110 is disposed on the display panel 100. Furthermore, the first adhesive layer 110 is disposed between the display panel 100 and the diffusion layer 120. The anti-glare film 130 is disposed on the diffusion layer 120.

In the present embodiment, the display panel 100 may be, for example, a self-luminous display panel for providing display light to form a display screen. In particular, the pixels of the self-luminous display panel may include, for example, organic light-emitting diodes (OLED) or micro light-emitting diodes (μLED), but the invention is not limited thereto. In other embodiments, the display panel 100 may also be a non-self-luminous display panel such as a liquid-crystal display (LCD), and the light source may be, for example, a sub-millimeter light-emitting diode (mini-LED) or a light-emitting diode (LED), but the invention is not limited thereto.

The first adhesive layer 110 may be, for example, an optically clear adhesive (OCA) coated on a surface 100A of the display panel 100 (for example, a direction X), so that the diffusion layer 120 may be bonded onto the surface 100A of the display panel 100 via the first adhesive layer 110, and lastly the optically clear adhesive is cured. In some embodiments, the visible light transmittance of the first adhesive layer 110 may be greater than or equal to 99%, but the invention is not limited thereto. In some embodiments, the first adhesive layer 110 may also be a solid adhesive base material. For example, the first adhesive layer 110 may be a plastic base material (such as a PET film). In a direction Y, two opposite sides of the first adhesive layer 110 have ultraviolet curable adhesive or thermal curable adhesive for respectively bonding one side of the diffusion layer 120 and the surface 100A of the display panel 100. The solid adhesive eliminates the need to consider issues such as adhesive staining, and has a better process margin when each film needs to be cut and produced. However, the invention is not limited thereto.

It is worth mentioning that the first adhesive layer 110 may be in direct contact with the display panel 100. In other words, the first adhesive layer 110 may be directly disposed outside the members of the display panel 100 and be in contact with the surface 100A of the display panel 100 (i.e., the display surface of the display panel 100), so that there is no air gap or bubble between the display panel 100 and the first adhesive layer 110. As a result, the probability of unexpected refraction, reflection, or interference of display light between the interfaces of different films may be reduced, thereby further reducing interference factors that may cause sparkling.

The diffusion layer 120 may be, for example, a solid optical diffusion sheet and has a high transmittance for visible light and an appropriate haze value, but the invention is not limited thereto. In some embodiments, the diffusion layer 120 may be a diffusion optically clear adhesive (DOCA), and has good visible light transmittance (for example, greater than 90%) and appropriate adhesion. In detail, the diffusion layer 120 may be the same optically clear adhesive material as the first adhesive layer 110, and includes a plurality of optical diffusion particles uniformly dispersed therein. The diffusion optically clear adhesive is applied and hardened in the surface direction of the display device 10 (for example, the direction X), but the invention is not limited thereto. When the adhesive portion of the diffusion layer 120 and the first adhesive layer 110 are made of the same material, the probability of unexpected refraction, reflection, and interference of the display light beam of the display panel 100 between different material layers may be reduced, thereby reducing the probability of generating stray light and improving display quality.

The anti-glare film 130 may further include a first material layer 131 and a second material layer 132, both of which together form the anti-glare film 130. For example, the first material layer 131 may be a PET film having a certain thickness D31, such as greater than or equal to 80 microns to less than or equal to 100 microns; and the second material layer 132 may be a hardened transparent plastic film obtained by a surface atomization treatment. When the external light beam from the display device 10 is irradiated on the second material layer 132, the second material layer 132 scatters the external light beam to further reduce the specular reflection of the light beam at a surface 132A of the second material layer 132, thereby achieving an anti-glare effect. A thickness D32 of the second material layer 132 is approximately greater than or equal to 4 microns and less than or equal to 5 microns. In some embodiments, the second material layer 132 may be other anti-reflective materials, but the invention is not limited thereto.

In some embodiments, the first material layer 131 and the second material layer 132 of the anti-glare film 130 may be composed of the same material. Specifically, the PET film forming the anti-glare film 130 may be prepared, and the surface of the PET film facing away from the display device 10 may be directly subjected to a surface atomization treatment to obtain the second material layer 132 and the first material layer 131 not subjected to an atomization treatment. In some embodiments, the surface 132A of the second material layer 132 may have a plurality of irregular and uneven optical microstructures to achieve the function of eliminating natural reflected light.

It is worth mentioning that in an embodiment of the invention, a thickness D2 of the diffusion layer 120 is greater than or equal to 15 micrometers (μm), so that the screen sparkling of the display device 10 may be reduced. Specifically, when the thickness D2 of the diffusion layer 120 is not thick enough, even if the haze of the diffusion layer 120 is increased, the effect of reducing screen sparkling is still limited. Via an embodiment of the invention, when the thickness D2 of the diffusion layer 120 is greater than or equal to 15 μm, for example, D2 is substantially 50 μm, and the diffusion layer 120 is attached onto the display panel 100 via the first adhesive layer 110, the diffusion layer 120 has the effect of reducing the sparkling of the display screen.

Moreover, if the thickness D2 of the diffusion layer 120 is too great, in addition to possibly reducing the resolution of the display screen, the display device 10 is also prone to white haze reflected light at various viewing angles due to external light, thus affecting the viewing experience of the display device 10. Specifically, the thickness D2 of the diffusion layer 120 may be less than or equal to 120 μm. While achieving the function of reducing sparkling, the influence of stray light caused by external reflected light may also be avoided.

Although not shown, in some embodiments, the display device 10 may also include other films. For example, a waterproof isolation layer or a protective cover may be further disposed on a surface (such as the surface 132A) of the anti-glare film 130 to further increase device reliability and strength of the display device 10, but the invention is not limited thereto.

Some other embodiments will be enumerated below to describe the invention in detail, wherein the same components are marked with the same reference numerals, and descriptions of the same technical content is omitted. For the omitted parts, please refer to the above embodiments, which are not be repeated hereafter.

FIG. 1B is a comparative schematic diagram of various modified embodiments of the display device of the first embodiment. Please refer to FIG. 1B, a display device 10A, a display device 10B, and a display device 10C are modified embodiments of the display device 10. Specifically, the thicknesses D1 of the first adhesive layers 110 of the display device 10A, the display device 10B, and the display device 10C are all substantially 125 μm; the thicknesses D2 of the diffusion layers 120 are substantially 50 μm; the total thicknesses (i.e., the sum of the thickness D1 of the first adhesive layer 110 and the thickness D2 of the diffusion layer 120) of the above two films are all 175 μm. Thicknesses D31 of the first material layers 131 of the anti-glare films 130 are all substantially 80 μm; and thicknesses D32 of the second material layers 132 are all substantially 5 μm. The difference between these modified embodiments and the display device 10 is that the haze value of the diffusion layer 120 is different. Specifically, the haze value of the diffusion layer 120 of the display device 10A is about 70%; the haze value of the diffusion layer 120 of the display device 10B is about 80%; and the haze value of the diffusion layer 120 of the display device 10C is about 90%.

It may be known from the comparison of FIG. 1B that when the haze value of the diffusion layer 120 is greater, for example, 70% or more, the effect of reducing the sparkling is better (for example, the anti-sparkling levels are all 3 or above, which is an acceptable level, and the anti-sparkling level may reach 4 or above, which is a good or even excellent level). However, the invention is not limited thereto. In other embodiments, the haze of the diffusion layer 120 may also be 70% or less (for example, substantially about 30%), and may also achieve an acceptable anti-sparkling effect (for example, the anti-sparkling level is about 3−). In particular, the sparkling level may be detected via a flash point tester (such as DM&S SMS-1000) or other detection devices, but the invention is not limited thereto.

Moreover, it is verified that the thickness D1 of the first adhesive layer 110 also affects the anti-sparkling level of the display device 10. For example, when the above conditions are all the same and only the thickness D1 of the first adhesive layer 110 is changed, it is found that as the thickness D1 is gradually increased, the anti-sparkling level of the display device 10 also tends to be increased. Specifically, in some embodiments, when the thickness D1 of the first adhesive layer 110 is 100 microns or more, the anti-sparkling level of the display device 10 may reach an acceptable level of about 3−. In some embodiments, the thickness D1 of the first adhesive layer 110 may be substantially 125 microns, but the invention is not limited thereto.

FIG. 1C and FIG. 1D are comparative schematic diagrams of various modified embodiments of the display device of the first embodiment. Please refer to FIG. 1C and FIG. 1D. The display device 10C and a display device 10D of the present embodiment are similar to the display device 10. The difference is the haze value and the placement position of the diffusion layer 120. For example, the haze value of the diffusion layer 120 of the display device 10C may be about 30%. The haze value of the diffusion layer 120 of the display device 10D is also about 30%, but the diffusion layer 120 of the display device 10D is disposed between the first adhesive layer 110 and the display panel 100, and two opposite sides of the diffusion layer 120 in the direction Y (that is, the thickness direction of the display device 10D) are in contact with the surface 100A of the display panel 100 and the first adhesive layer 110.

Via inspection, it may be found that when the diffusion layer 120 of the display device 10D is configured, the sparkling reduction effect thereof is worse, for example, the anti-sparkling level is about 2. The display device 10C may have a better anti-sparkling level, for example, around anti-sparkling level 3. Acceptable levels may be achieved. Similar to the above, the greater the thickness D1 of the first adhesive layer 110 below the diffusion layer 120 is, the more the anti-sparkling effect of the display device 10C may be increased.

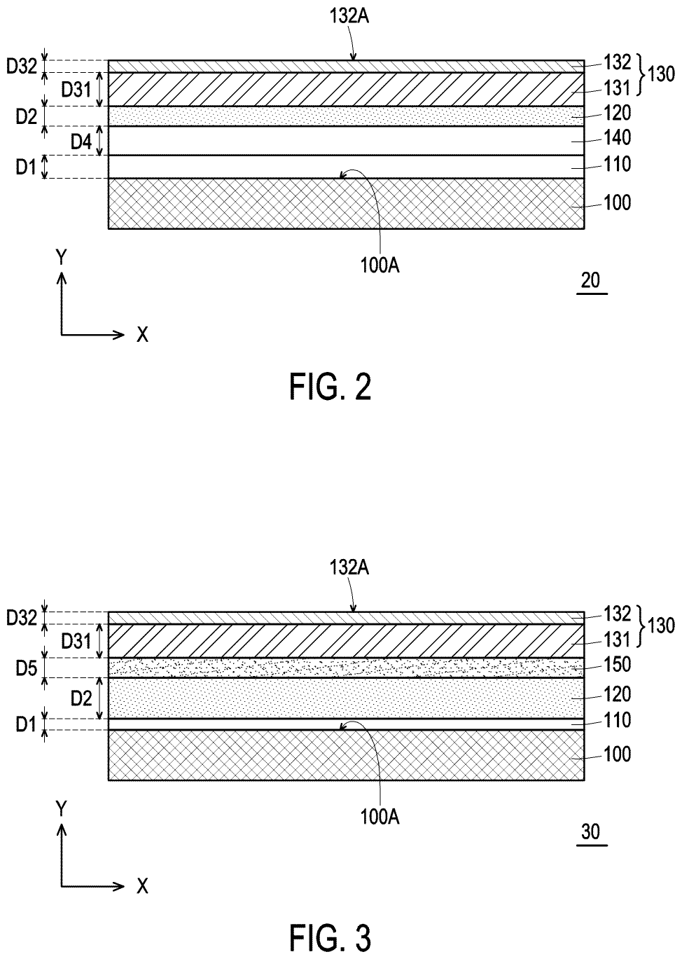

FIG. 2 is a cross-sectional schematic diagram of a display device according to the second embodiment of the invention. Please refer to FIG. 2. A display device 20 is similar to the display device 10. The difference is that the films at two sides of the first adhesive layer are different. Specifically, the display device 20 further includes a base material 140 disposed between the first adhesive layer 110 and the diffusion layer 120, and the material of the base material 140 includes polyethylene terephthalate (PET), cellulose triacetate (TAC), optical-grade polymethylmethacrylate PMMA, or polycarbonate (PC), and the first adhesive layer 110 may be the above optically clear adhesive.

Specifically, in the display device 20, the first adhesive layer 110 may be coated on the solid base material 140, and the base material 140 is attached onto the surface 100A of the display panel 100 via the first adhesive layer 110, but the invention is not limited thereto. In some embodiments, the first adhesive layer 110 and the base material 140 may be made of the same material to reduce unexpected phenomena such as refraction, reflection, or interference of light beams between different interfaces. From another perspective, the adhesive layer between the display panel 100 and the diffusion layer 120 in the display device 20 may be a composite material composed of the first adhesive layer 110 and the base material 140. Similar to the above, the solid base material 140 has less issues such as adhesive staining, and has a better process margin when each film needs to be cut and produced, thereby increasing the process feasibility of the display device 20.

Moreover, the base material 140 may have an appropriate thickness D4, and the range of the thickness D4 may be greater than or equal to 40 μm; and the thickness D1 of the first adhesive layer 110 may be substantially 50 μm. Therefore, the sum of the thickness D4 and the thickness D1 of the present embodiment may be similar to the thickness D1 of each first adhesive layer 110 of the previous embodiment, and the optical effect of the display device 10 may also be achieved, which is not described again here.

FIG. 3 is a cross-sectional schematic diagram of a display device according to the third embodiment of the invention. Please refer to FIG. 3. A display device 30 is similar to the display device 10. The difference is that the thickness of the diffusion layer 120 and the types of each film are different.

In detail, the thickness D2 of the diffusion layer 120 of the display device 30 may be greater than or equal to 120 microns. Accordingly, the anti-sparkling effect of the display device 30 may be improved. In order to alleviate the issue of visual interference caused by white fog-like reflected light if the thickness D2 of the diffusion layer 120 is too large, the display device 30 further includes a second adhesive layer 150 disposed between the anti-glare film 130 and the diffusion layer 120 and respectively in contact with and adhered to the diffusion layer 120 and the first material layer 131 of the anti-glare film 130 by using two opposite sides (for example, two opposite sides in the direction Y) of the second adhesive layer 150. It is worth mentioning that in addition to using the same adhesive material as the first adhesive layer 110 in the second adhesive layer 150 to avoid unexpected refraction, reflection, or interference phenomena from affecting display quality, a plurality of light-absorbing materials evenly distributed in the second adhesive layer 150 may also be included.

For example, the second adhesive layer 150 may be a black optically clear adhesive (BOCA), and the plurality of light-absorbing materials may be graphite or dark dye, etc., but the invention is not limited thereto. The light-absorbing materials dispersed in the black optically clear adhesive are used to absorb a portion of the light from the outside, thereby reducing the generation of white fog-like reflected light and improving visual experience. In some embodiments, the entire second adhesive layer 150 may have an appropriate visible light absorption rate. For example, the absorption rate of the second adhesive layer 150 in the visible light band may be greater than or equal to 40%. While achieving the function of absorbing stray light, excessive display light is not absorbed, so as to avoid issues such as excessively dark display light. Moreover, the second adhesive layer 150 may have an appropriate thickness D5. For example, the value of the thickness D5 may be greater than or equal to 15 μm, for example, substantially 50 μm, so as to achieve a better effect of absorbing stray light.

Based on the above, in the display device of the invention, the diffusion layer is disposed between the first adhesive layer and the anti-glare film, and the thickness of the diffusion layer is controlled to be greater than or equal to 15 microns, thus effectively reducing the optical interference generated between the anti-glare film and other films, and further reducing the sparkling of the display screen, and the anti-glare film may also maintain the anti-reflective function thereof. The display device according to an embodiment of the invention may provide a good display screen and provide a good viewing experience in an environment in which the natural light is too strong or too dark, and in the front or side viewing angle of the display device.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A display device, comprising:
a display panel;
a first adhesive layer disposed on the display panel;
a diffusion layer, wherein the first adhesive layer is disposed between the display panel and the diffusion layer; and
an anti-glare film disposed on the diffusion layer, wherein a thickness of the diffusion layer is greater than or equal to 15 microns.

2. The display device of claim 1, wherein a haze of the diffusion layer is greater than or equal to 70%.

3. The display device of claim 1, wherein a thickness of the diffusion layer is less than or equal to 120 microns.

4. The display device of claim 1, wherein a thickness of the first adhesive layer is greater than or equal to 100 microns.

5. The display device of claim 1, further comprising:
a base material disposed between the first adhesive layer and the diffusion layer, wherein a material of the base material comprises polyethylene terephthalate, and the first adhesive layer is an optically clear adhesive.

6. The display device of claim 5, wherein a thickness of the base material is greater than or equal to 40 microns, and a thickness of the first adhesive layer is substantially 50 microns.

7. The display device of claim 1, further comprising:
a second adhesive layer disposed between the anti-glare film and the diffusion layer, wherein the second adhesive layer comprises a light-absorbing material.

8. The display device of claim 7, wherein a thickness of the diffusion layer is greater than or equal to 120 microns, and a thickness of the second adhesive layer is greater than or equal to 15 microns.

9. The display device of claim 7, wherein a visible light transmittance of the second adhesive layer is greater than or equal to 40%.

10. The display device of claim 1, wherein a side of the anti-glare film away from the display panel has a plurality of optical microstructures.
